(19) United States
(12) Patent Application Publication
(10) Pub. No.: US 2025/0075121 A1
(43) Pub. Date: Mar. 6, 2025

(54) ANTI-FOAMING FORMULATIONS BASED ON SILICONES AND FLUOROSILICONES AND METHOD FOR REDUCING FOAM IN PETROLEUM

(71) Applicants: PETRÓLEO BRASILEIRO S.A. – PETROBRAS, Rio de Janeiro (BR); UNIVERSIDADE FEDERAL DO RIO DE JANEIRO - UFRJ, Rio de Janeiro (BR)

(72) Inventors: OSVALDO KARNITZ JUNIOR, Rio de Janeiro (BR); ROBSON PEREIRA ALVES, Rio de Janeiro (BR); CLAUDIA REGINA ELIAS MANSUR, Rio de Janeiro (BR); RAFAEL FARIAS PEREZ, Rio de Janeiro (BR); MARIANA TEIXEIRA MENDES, Rio de Janeiro (BR)

(73) Assignees: PETRÓLEO BRASILEIRO S.A. – PETROBRAS, Rio de Janeiro (BR); UNIVERSIDADE FEDERAL DO RIO DE JANEIRO - UFRJ, Rio de Janeiro (BR)

(21) Appl. No.: 18/767,043

(22) Filed: Jul. 9, 2024

(30) Foreign Application Priority Data
Aug. 28, 2023 (BR) 1020230172709

(51) Int. Cl. C09K 8/584

(52) U.S. Cl. CPC C09K 8/584

(57) ABSTRACT

This invention describes formulations based on silicone and fluorosilicone, in the form of solutions or emulsions, useful for the chemical treatment of petroleum foam during primary processing and their implementation method. Said formulations, in the form of emulsions, also comprise additional components in the form of surfactants, capable of maximizing the anti-foaming action of the formulations in petroleum.

### FIELD OF THE INVENTION

This invention falls within the field of chemical treatment of petroleum, water and gas and their emulsions and foams in primary petroleum processing. More specifically, this invention discloses anti-foaming formulations based on silicone and fluorosilicone and their implementation method for the chemical treatment of foam in petroleum.

### BACKGROUND OF THE INVENTION

During petroleum production, the decompression of fluids from the reservoir causes the formation of foam inside the liquid and gas separating vessels. The foam generated prevents the separation and purification of these phases in the primary petroleum treatment plant, in addition to causing operational problems that can range from reducing the campaign time of equipment and systems to causing production to stop in the gas and oil treatment plant.

Combined with these characteristics of petroleum production, in view of the discovery of reservoirs at great distances from the coast, in large water depths, there is currently a tendency to reduce the size and weight of the primary processing plant, which results in increasingly to significantly increase the dosage of anti-foaming required for the treatment.

Silicones and their derivatives are the active material with technical and economic viability of all anti-foaming products for petroleum. However, this product, as it contains silicon in its composition, leads to contamination of the petroleum with silicon. In production units that require higher dosages of this product, consequently, the treated petroleum will have greater contamination with silicon.

Silicon, coming from anti-foaming agents, can be deposited on catalysts in refining and petrochemical units, reducing the campaign time of these units (Kapusta, Sergio D., van den Berg, Frans, Daane, Rinus, and Morris C. Place, “The Impact of Oil Field Chemicals on Refinery Corrosion Problems”, Corrosion, 2003, San Diego, California).

It is known that anti-foaming products based on polydimethylsiloxane have been used in petroleum production since 1970, and since 1980 it has established itself as the only type of raw material used for petroleum treatment (Pape, P. G. Silicones: Unique Chemical for Petroleum Processing. Journal of Petroleum Technology, volume 35, June 1983; Hera, J., & Gingrich, R. Overcoming the Unique Production Chemistry Challenges of Subsea Separation, and Subsea Boosting for the Parque das Conchas (BC-10) Development. Offshore Technology Conference, May 2010).

The Patent U.S. Pat. No. 5,454,979 demonstrates that, at this time, polydimethylsiloxane and fluorosilicones (block copolymers of polydimethylsiloxane and fluoroquil- polydimethylsiloxane) were already commercially used for this implementation. More recently, it was discovered that polyether silicone polymers also showed anti-foaming action for petroleum and there are already some, although scarce in the literature, industrial implementations of this product (Fraga, A. K. et al. “Development and evaluation of oil in water nanoemulsions based on polyether silicone as demulsifier and antifoam agents for petroleum”, Journal of Applied Polymer Science, Volume 131, October 2014).

The Patent U.S. Pat. No. 5,853,617 has also evaluated the combined use (co-injection) of two products: one based on fluorosilicone and the other based on silicone, to enhance the anti-foaming action in petroleum. Although co-injection increases the efficiency of products in combating foam and can reduce oil contamination by silicon, allowing process control, this technology has the major disadvantage of needing to duplicate the anti-foaming injection system in industrial plants. This difficulty arises from the fact that silicone and fluorosilicone are insoluble in each other. This characteristic of insolubility between these active materials makes it extremely difficult to formulate a combined solution between them. In the literature, the formulation of anti-foaming agents with both active materials in a single industrial product is unknown. It is also noteworthy that the use of active material from anti-foaming additives in emulsions based on water, with only one active material, silicone or fluorosilicone, is also well described in the literature, in the Patent GB 2234978 and in the application GB 2244279.

Thus, currently, the chemical treatment of petroleum foam occurs by injecting, through dosing systems, an anti-foaming additive or two anti-foaming additives through different dosing systems, at some dosing points in the industrial primary processing plant of petroleum. However, in the literature, the dispersion of the active materials silicone and fluorosilicone in a single industrial product, such as this invention, is unknown.

In particular, it is known that the application BR 11201500372-7 relates to the same technical field as this invention, presenting a composition that contains a preformed anti-foaming emulsion, including a continuous hydrophilic phase and a polyorganosiloxane dispersed in the hydrophobic phase, wherein said polyorganosiloxane may be a branched or linear polydimethylsiloxane (PDMS). However, these formulations contain only one active material (polydimethylsiloxane), while the formulation disclosed in this invention concerns obtaining formulations with two different active materials (PDMS and fluorosilicone).

The patents U.S. Pat. No. 7,060,662 B2 and EP 0 761 805 B1 also present lubricating mineral oil formulations that may contain two anti-foaming active materials (PDMS and fluorosilicone). However, such patents have different applicability, in addition to using anti-foaming agents in dosages in the parts per million range, in lubricating oils that are used as purchased, not being dosed, in the parts per million range, for their use. This invention discloses much more concentrated dispersions of PDMS and fluorosilicone, which are used in primary petroleum processing, where they are dosed in parts per million in the fluids arriving from the wells.

The application US 2021179930 discloses anti-foaming and demulsifier compositions for hydrocarbon oils, which comprise one or more anti-foaming agents based on silicone, or combinations thereof, including polysiloxane (silicone), such as polydimethylsiloxane (PMDS) and a fluorosilicone (such as trifluoropropylmethylsiloxane (TFP)) and combinations thereof. However, it presents a very generic solution that does not present any anti-foaming composition containing the two active materials PDMS and fluorosilicone, as can be seen in the examples in the text. Furthermore, the expression that includes “any combination” of the mentioned components does not make it clear that the solution would be a single formulation containing several different active materials and more specifically PDMS and fluorosilicone or several formulations containing some active materials.

Therefore, the knowledge form the state of the art, whether analyzed alone or in combination, does not result in anti-foaming and defoaming formulations such as those of this invention, which differs mainly due to: (i) obtaining formulations with two different active materials simultaneously (silicone and fluorosilicone); (ii) in concentrations in the mass/mass percentage range; (iii) formulations that would be dosed in petroleum production units, in the ppm range; and (iv) formulations based on water or hydrophilic organic solvent; (v) some of the formulations, in the form of emulsions, containing surfactants Tween 80 and Span 80, in certain proportions, managed to further maximize the anti-foaming action of the petroleum formulation, when considering another means of adding the two active materials.

### BRIEF DESCRIPTION OF THE INVENTION

This invention falls within the field of chemical treatment of petroleum, gas and water and their foams and emulsions during primary processing. More specifically, this invention discloses anti-foaming formulations based on silicone and fluorosilicone and their implementation method for the chemical treatment of foam in petroleum.

This invention describes anti-foaming and defoaming formulations for petroleum, which can be presented in the form of a solution or emulsions. In solution form, the formulations comprise 2 to 30% by weight of silicones, 0.45 to 5% by weight of fluorosilicones and 65 to 97.5% of hydrophilic organic solvents. In the form of emulsions, the formulations present water as a dispersant, in the same dosages of active material and also include surfactants present in amounts of 2 to 22% by mass.

This invention further describes a method for reducing foaming in petroleum, which comprises applying the formulations described herein in an injection system in the industrial plant during primary petroleum processing.

### DETAILED DESCRIPTION OF THE INVENTION

This invention falls within the field of chemical treatment of petroleum and its emulsions by describing anti-foaming and defoaming formulations based on silicone and fluorosilicone and their implementation method for the chemical treatment of foam in petroleum.

Said formulations are useful for use in primary petroleum processing and contain two anti-foam active materials (silicone and fluorosilicone) through solvency in organic solvent or through dispersion in the form of emulsions. The formulations as described below have an anti-foaming action enhanced by the combined use of active materials and allow the use of just one injection system in the industrial plant (instead of two).

In the form of emulsions, the formulations have greater efficiency in combating foam, when compared to dosing both active materials separately or dosing both active materials in solvent, in addition to allowing the possibility of making more specific formulations for each type of oil, by varying the amounts of surfactants in the formulations.

Said formulations comprise from 2.0 to 30% by mass, preferably 4.5% by mass, of silicones, 0.45 to 5% by mass, preferably 1% by mass, of fluorosilicones, and 65 to 97.5% by mass, preferably 94.5% by mass, of organic solvents. In the form of emulsions, the formulations comprise 2.0 to 30% by mass of silicones, preferably 4.5% by mass, 0.45 to 5% by mass of fluorosilicones, preferably 1% by mass, and additionally comprise one or more surfactants present in amounts of 2 to 22%, preferably 10% by mass, where the dispersing phase is water.

More specifically, the silicones of said formulations are selected from the group comprising linear, cyclic or branched chain polydimethylsiloxane (PDMS), with viscosity varying from 5 to 100,000 cSt (5×10⁻⁶ m²/s to 0.01 m²/s) (non-limiting), with hydroxy, dimethyl, trimethyl siloxy, or vinyl ending; PDMS copolymers formed by replacing one or more methyl groups with alkyl, aryl, ether, halogenated and/or amide/amine. The fluorosilicones of this invention are selected from the group comprising trifluoropropylmethylsiloxane (TFP) of 60 to 10.000 cSt (6×10⁻⁵ m²/s to 0.01 m²/s), nonafluorohexylmethylsiloxane (NFH) of 300 to 800 cSt (0.0003 m²/s to 0.0008 m²/s), tridecafluorooctylsiloxane (TDFO) from 60 to 500 cSt (6×10⁻⁵ m²/s to 0.0005 m²/s), or other CₙF₂ₙ₊₁(CH₂)O chain fluorosilicone, with 4≤n≤16, or block copolymer of polydimethylsiloxane and fluoroquil-polydimethylsiloxanefluorosilicone, with alkyl or phenyl branches. The organic solvents of this invention are selected from the group comprising butanone, pentanone and ethyl acetate. The surfactants of the formulations of this invention are selected from Span 80, Tween 80, dodecylbenzenesulfonic acid (DBSA); sodium dodecylbenzene sulfonate (SDBS); ethoxylated nonylphenol with an ethoxy chain of 2 to 20 units, more specifically 9.5 units (NP95); ethoxylated alcohols, more specifically, Alkonat L70 and L90; polyethylene glycol, polypropylene glycol, or copolymer composed of both, more specifically pluronic 31R1; Sodium lauryl sulfate; polyvinyl alcohol (PVA) and polyvinylmethylether, in a non-limiting way.

A method for reducing foam in petroleum is further disclosed, comprising applying said formulations, through an injection system in the industrial plant, to the currents produced during primary processing of petroleum.

### EXAMPLES OF EMBODIMENT

Physical process simulations were carried out in the laboratory, with the aim of evaluating the efficiency of the formulations of this invention.

This invention is further illustrated with reference to the following examples that describe both the preparation of emulsions and their effectiveness as anti-foaming additives.

For the preparation of emulsions, polydimethylsiloxane (PDMS) with viscosity varying between 100 and 10.000 cSt (0.0001 m²/s and 0.01 m²/s), fluorosilicones with different viscosity and branch sizes were used, for example, trifluoropropylmethylsiloxane (TFP) with viscosities between 60 and 10.000 cSt (6×10⁻⁵ m²/s and 0.01 m²/s), nonafluorohexylmethylsiloxane (NFH) between 300 and 800 cSt (0.0003 m²/s and 0.0008 m²/s) and tridecafluorooctylsiloxane (TDFO) between 100 and 500 cst (0.0001 m²/s and 0.0005 m²/s), and surfactants selected from the group comprising Tween 80, Span 80, dodecylbenzenesulfonic acid (DBSA); sodium dodecylbenzene sulfonate (SDBS); ethoxylated nonylphenol with an ethoxy chain of 2 to 20 units, more specifically 9.5 units (NP95); ethoxylated alcohols, more specifically, Alkonat L70 and L90; polyethylene glycol, polypropylene glycol, or copolymer composed of both, more specifically pluronic 31R1; Sodium lauryl sulfate; polyvinyl alcohol (PVA) and polyvinylmethylether.

The anti-foaming formulation of this invention has an HLB of 4.3 to 15, ICE of 0.2 to 0.81 and in the form of emulsions in water, the drops have an average size of 2 to 10 μm.

### Example 1

PDMS 1,000 cSt (0.001 m²/s) and fluorosilicone TFP 300 cSt (0.0003 m²/s) were mixed with the surfactant under magnetic stirring for 15 minutes. After this period, distilled water was added to the mixture and the solution was stirred for 24 hours. Finally, the emulsions were processed in the Ultrasonic Processor for 10 minutes, at room temperature (25° C.). The silicone content used was 4.5% of the emulsion volume, the fluorosilicone content was 0.9%, with the addition of 2% Tween 80 surfactants. The remaining percentage was composed of distilled water.

### Example 2

150 mL of duly homogenized 30° API petroleum were transferred to a compression cell, without the presence of the additive formulation. The cell was closed, vigorously shaken for about 2 minutes and placed in a rolling oven for a period of 120 minutes at a temperature of 30° C. At the end, the tank was pressurized with compressed air at 200 psi (1.4 MPa) for 3 minutes and taken back to the rolling oven for another 60 minutes. Then, the bowl was positioned with the outlet valve downwards and the spiral was connected to its valve. The petroleum was then decompressed into the 100 ml beaker at the same oven temperature until a volume of approximately 80 mL was reached. The volume of foam formed was measured every 15 seconds until a constant value. All tests were performed at least in duplicate. Subsequently, tests were carried out with the emulsion described in Example 1, with 20 ppm being dosed into the petroleum before closing the cell.

To calculate the foam content formed, the following equation was used:

$$FOAM ( \% v / v ) = ( H - {H}_{F} ) / {H}_{F} \times 100$$

Where H is the volume reached by the foam on the scale, at each time interval and H_{F} is the final volume reached by the liquid after breaking all the foam formed. The Foaming Index (ICE) takes into account the sum of the percentages of foam formed in the petroleum sample with the surfactants evaluated over time until stabilization in comparison to the petroleum sample without additive, according to equation (1) below:

ICE=(Σ% oil foam−Σ% surfactant foam)/Σ% oil foam (1)

Where Σ (% oil foam) refers to the sum of percentages of foam formed in the petroleum sample without additive over time; Σ (% surfactant foam) refers to the sum of the oil sample dosed with the surfactants to be evaluated over time. The ICE value ranges from 0 to 1, with interest in the value closest to 1.

### Examples 3 to 14

Example 2 was repeated with a change in the concentration of emulsifying surfactants. The composition of the emulsions and their visual characteristics are listed in Table 1. As expected, due to the amount of water in the composition, the viscosities of all emulsions were close to 1 cP.

TABLE 1
Composition and visual characteristics of the emulsions produced

| | PDMS | TFP | | | | |
|---|---|---|---|---|---|---|
| | 1,000 | 300 | Tween | Span | | Translucency/ |
| Example | cSt | cP | 80 | 80 | Water | Stability |
| 2 | 4.5 | 0.9 | 2 | 0 | 92.6 | clear |
| 3 | 4.5 | 0.9 | 2 | 1 | 91.6 | milky, stable |
| 4 | 4.5 | 0.9 | 2 | 3 | 89.6 | milky, stable |
| 5 | 4.5 | 0.9 | 2 | 5.5 | 87.1 | milky, stable |
| 6 | 4.5 | 0.9 | 2 | 8 | 84.6 | milky, stable |
| 7 | 4.5 | 0.9 | 2 | 12 | 80.6 | milky, stable |
| 8 | 4.5 | 0.9 | 2 | 20 | 72.6 | milky, stable |
| 9 | 4.5 | 0.9 | 0 | 2 | 92.6 | milky, stable |
| 10 | 4.5 | 0.9 | 1 | 2 | 91.6 | milky, stable |
| 11 | 4.5 | 0.9 | 3 | 2 | 89.6 | milky, stable |
| 12 | 4.5 | 0.9 | 5.5 | 2 | 87.1 | milky, stable |
| 13 | 4.5 | 0.9 | 8 | 2 | 84.6 | milky, stable |

### Examples 14 to 17

A series of experiments were carried out, by way of comparison, by dosing, at the same concentration, 20 ppm, of each example. The following was used:
a) Commercial sample of anti-foaming based on PDMS (DOWSIL™ 9945);
b) Sample of 9% PDMS solubilized in organic solvent;
c) Sample of physical mixture PDMS 4.5%+TFP 0.9% in organic solvent;
d) API 30° API petroleum without addition of anti- foaming formulation.

Table 2 shows the hydrophilic-lipophilic balance (HLB) values and the average droplet size of the emulsions; the results of the initial percentage of foam formed (% foam) and the anti-foaming index (ICE) for the examples described.

TABLE 2
Hydrophilic-lipophilic balance, average droplet size,
initial percentage of foam formed and anti-foaming
index of the samples presented in this invention

| | Anti-foaming | | Average | % initial | |
|---|---|---|---|---|---|
| Example | formulation | HLB | size (μm) | foam | ICE |
| 2 | Si4.5F0.9T2S0 | 15.0 | 4.52 | 85 | 0.37 |
| 3 | Si4.5F0.9T2S1 | 11.4 | 4.66 | 74 | 0.39 |
| 4 | Si4.5F0.9T2S3 | 8.6 | 5.17 | 59 | 0.56 |
| 5 | Si4.5F0.9T2S5.5 | 7.2 | 2.78 | 33 | 0.76 |
| 6 | Si4.5F0.9T2S8 | 6.4 | 2.43 | 26 | 0.81 |
| 7 | Si4.5F0.9T2S12 | 6.0 | 2.25 | 80 | 0.31 |
| 8 | Si4.5F0.9T2S20 | 5.0 | 2.22 | 73 | 0.41 |
| 9 | Si4.5F0.9T0S2 | 4.3 | 3.91 | 46 | 0.64 |
| 10 | Si4.5F0.9T1S2 | 7.9 | 5.43 | 54 | 0.55 |
| 11 | Si4.5F0.9T3S2 | 10.7 | 4.66 | 63 | 0.52 |
| 12 | Si4.5F0.9T5.5S2 | 12.1 | 4.22 | 91 | 0.36 |
| 13 | Si4.5F0.9T8S2 | 12.9 | 4.05 | 109 | 0.20 |
| 14 | Commercial sample | — | — | 23.5 | 0.78 |
| | PDMS 27.5% | | | | |
| 15 | PDMS 1,000 cSt 9% | — | — | 26 | 0.71 |
| | butanone | | | | |
| 16 | PDMS 4.5% TFP | — | — | 39 | 0.57 |
| | 0.9% butanone | | | | |
| 17 | 30° API petroleum | — | — | 106.7 | — |

From the results shown in the Examples, it can be seen that increasing the content of the Span 80 additive in the emulsion increases the index of foam action in 30° API petroleum, reaching the value of 0.81 for the Span 80 concentration of 8% (formulation Si4.5F0.9T2S8). It is noteworthy that this formulation has a lower level of siliconized active material in relation to the commercial anti-foaming product and the solution of siliconized active materials in butanone. so, Even this formulation (formulation Si4.5F0.9T2S8) had an efficiency value similar to that of the commercial product sample, containing 27.5% active material (PDMS), which showed an ICE value of 0.78, and surpasses the efficiency of the PDMS 1,000 cSt 9% butanone formulation, which showed an ICE value of 0.71. It is noted that, with the increase in the amount of Span 80, the formulation showed a tendency to reduce the size of emulsion droplets, as well as the HBL value. Namely, the formulation without Span (Si4.5F0.9T2S0) had a droplet diameter of 4.5 μm, while the formulation with 20% Span 80 (Si4.5F0. 9T2S20) had a droplet diameter of 2.2 um. For the sample whose formulation was Si4.5F0.9TOS2, an ICE of 0.64 was observed. The increase in Tween in the formulation, series called Si4.5F0.9TXS2, where the value of X showed discrete values between 1 and 8, led to a reduction in anti-foaming performance, with a reduction in the ICE value of up to 0.20, in the Si4.5F0.9T8S2 formulation. Unlike the first group of formulations, in this group the emulsion droplet size ranged from 4 to 5.4 μm. It is also noteworthy that there is no trend between the anti-foaming activity of the formulation and HBL.

This invention has the following advantages:
Economic/Productivity: reduction of the possibility of depreciation or rejection of petroleum, since the formulations being described provide a reduction in the dosage of silicon in petroleum. Formulations with lower levels of active material and/or using water as a vehicle tend to have lower production costs than the commercial product (higher content of active material and using mineral oil as a solvent);
Process safety: formulations based on water are not flammable or combustible;
Reliability: the reduction in silicon content increases the campaign time in the refining catalytic units, whose operating costs are currently being increased by the poisoning or deactivation of these catalysts by silicon; and
Environmental: reduction of the toxicity of the additive for formulations that use water as a dispersant, which is less toxic (when considering organic solvents) to humans and the environment.

Those skilled in the art will value the knowledge being presented and will be able to reproduce the invention in the presented embodiments and in other variants, covered within the scope of the attached claims.

1. An anti-foaming formulation for petroleum that is in the form of a solution or emulsion,
wherein, in the form of a solution, it comprises 2 to 30% by mass of silicones, 0.45 to 5% by mass of fluorosilicones and 65 to 97.5% of organic solvents, and
wherein, in the form of an emulsion, where the active materials are dispersed in water, it additionally comprises one or more surfactants present in amounts of 2 to 22% by mass.

2. The formulation according to claim 1, wherein the silicones are present preferably in 4.5% by mass, and are selected from the group comprising linear, cyclic or branched chain polydimethylsiloxane (PDMS), with viscosity varying from 5 to 100,000 cSt (5×10⁻⁶ m²/s at 0.1 m²/s), with hydroxy, dimethyl, trimethyl siloxy, or vinyl ending; PDMS copolymers formed by replacing one or more methyl groups with alkyl, aryl, ether, halogenated and/or amide/amine.

3. The formulation according to claim 1, wherein the fluorosilicones are preferably present in 1% by weight, and are selected from the group comprising trifluoropropylmethylsiloxane (TFP), nonafluorohexylmethylsiloxane (NFH), tridecafluorooctylsiloxane (TDFO), or other CₙF₂ₙ₊₁(CH₂)₂O chain fluorosilicone, with 4≤n≤16, or block copolymers of polydimethylsiloxane and fluoroalkyl-polydimethylsiloxane, with alkyl or phenyl branches.

4. The formulation according to claim 1, wherein when in the form of a solution, organic solvents are preferably present in 94.5% by mass, and are selected from the group comprising butanone, pentanone and ethyl acetate, and wherein, in the form of an emulsion, the dispersing phase is preferably water.

5. The formulation according to claim 1, wherein the surfactants are present preferably in 10%, and are selected from the group comprising Span 80, Tween 80, dodecylbenzenesulfonic acid (DBSA), sodium dodecylbenzene sulfonate (SDBS), ethoxylated nonylphenol with an ethoxy chain of 2 to 20 units, more specifically 9.5 units (NP95); ethoxylated alcohols, more specifically, Alkonat L70 and L90; polyethylene glycol, polypropylene glycol, or copolymer composed of both, more specifically pluronic 31R1; Sodium lauryl sulfate; polyvinyl alcohol (PVA) and polyvinylmethyl ether.

6. The formulation according to claim 1, wherein in the form of emulsions, in water, the drops have an average size of 2 to 10 μm.

7. The formulation according to claim 1, characterized by having an HLB of 4.3 to 15.

8. The formulation according to claim 1, wherein the ICE is 0.2 to 0.81.

9. A method for reducing foam in petroleum by applying the formulation, as defined in claim 1, through an injection system in the industrial plant in the streams produced during primary petroleum processing.
